(19) United States
(12) Patent Application Publication
(10) Pub. No.: US 2012/0011408 A1
(43) Pub. Date: Jan. 12, 2012

(54) GRAPHICAL USER INTERFACE SYSTEM FOR BACKGROUND INTELLIGENT TRANSFER SERVICE

(75) Inventors: Kumar Swamy, Bangalore (IN); Swetha Bharathraj Shetty, Karnataka (IN); Seshadri Rajamannar, Bangalore (IN); Raghavendra Marutirao Banappanavar, Bangalore (IN)

(73) Assignee: UNISYS CORPORATION, BLUE BELL, PA (US)

(21) Appl. No.: 12/859,365

(22) Filed: Aug. 19, 2010

(30) Foreign Application Priority Data
Jul. 7, 2010 (IN) 1595/DEL/2010

(51) Int. Cl. G06F 11/07; G06F 3/048

(52) U.S. Cl. 714/57; 715/808; 714/E11.025

(57) ABSTRACT

A graphical user interface system for BITS. The system includes a set of input modules, a set of output modules, and notification modules. The set of input modules allow selection of files for transfer to the BITS Server Virtual Directory and activate BITS functions. The BITS functions may include starting file transfer, cancelling file transfer, retrying file transfer, or removing the selected files. The set of output modules show dynamic status and real-time progress of the transfer automatically upon activation of the transfer of the selected files. The set of output modules also display an error message upon detecting an error in the transfer. Further, the notification modules provide a real-time notification on completion of the transfer.

### FIELD

This application deals generally with the Background Intelligent Transfer Service (BITS), and more particularly to managing file transfer in BITS.

### BACKGROUND

Generally, Microsoft Windows operating systems' Background Intelligent Transfer Service (“BITS”) is used to deliver software updates to clients and facilitate prioritized, throttled, and asynchronous transfer of files between a client and a server using idle network bandwidth. Three types of BITS transfer jobs exist—a download job, an upload job, and an upload-reply job. A download job downloads files to the client, an upload job uploads a file to the server, and an upload-reply job uploads a file to the server and receives a reply file from the server application. Along with the transfer, BITS also provides progress information related to the transfer jobs.

While a download job can have any number of files, upload jobs can have only one file. To upload files to the server, the server should include BITS server software and Internet Information Services (“IIS”) installed thereon. The BITS server extends IIS to support uploads that may be re-started. To use the upload feature, a BITS Server Virtual Directory is created on the server where the files are to be uploaded. Similarly, the files can be downloaded from the Server Virtual Directory. BITS adds properties to the IIS metabase for the virtual directory and uses the properties to determine how to upload or download the files.

Typically, BITS transfers files on behalf of requesting applications and continues to transfer the files in the background if a user who initiated the transfer remains logged on and a network connection is maintained. BITS suspends an ongoing transfer if the network connection is lost or if the user logs off. In such a scenario, BITS preserves the transfer information, and when the computer is turned on later and the network connection is restored, BITS resumes the transfer from where it was disconnected.

Generally, BITS Administration Utility (“BITSAdmin”), which enables interaction with the operating system only by typing commands, manages BITS jobs. To begin a BITS session, a job is created and files are added therein by specifying the source and destination's Uniform Resource Identifiers (“URIs”) by typing commands using command-line interface of the BITSAdmin. The user needs to enter a command to start, stop, resume, or query the status of the BITS job.

Accordingly, BITS is a text-only interface providing little flexibility and may be cumbersome for the user. Further, BITS mandates the use of command line interface commands for performing various functions related to BITS jobs.

### SUMMARY

At present, there exists a need for a user-friendly interface to manage file transfers in BITS and for eliminating the need for operating with an excessive command line code.

The instant application discloses a graphical user interface system for BITS. The system includes a set of input modules, a set of output modules, and notification modules. The set of input modules allow selection of files for transfer from BITS Server Virtual Directory and activate BITS functions. The BITS functions may include starting file transfer, cancelling file transfer, retrying file transfer, or removing the selected files. The set of output modules show dynamic status and real-time progress of the transfer automatically upon activation of the transfer of the selected files. The set of output modules also display an error message upon detecting an error in the transfer. Further, the notification modules provide a real-time notification on completion of the transfer.

The instant application also discloses a computer-implemented method for operating a graphical user interface system for BITS. The method includes activating an input module for selecting files for transfer. After selecting the files, the method activates an input module for initiating transfer of the selected files, and automatically shows dynamic status and real-time progress of the transfer in output modules. Further, the method includes displaying automatically an error message upon detection of an error in the transfer. The error message is displayed in an output module. Once the file transfer is complete, the method includes sending a real-time notification on completion of the transfer.

### BRIEF DESCRIPTION OF THE DRAWINGS

The figures described below and attached hereto set out and illustrate a number of exemplary embodiments of the disclosure. Throughout the drawings, like reference numerals refer to identical or functionally similar elements. The drawings are illustrative in nature and are not drawn to scale.

FIG. 1 is an exemplary embodiment of a graphical user interface system for Background Intelligent Transfer Service (BITS).

FIGS. 2A and 2B illustrate an exemplary embodiment of a method for facilitating transfer of files in BITS using the graphical user interface system of FIG. 1.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the instant disclosure describes a graphical user interface system for BITS. The interface system provides a platform to a user for interacting with BITS in ways other than typing command lines in the text-only BITS interface. As opposed to the conventional text-only interface, the interface system of the instant disclosure provides graphical icons, such as buttons and various visual indicators, such as pop-up boxes to represent the information and actions available to the user.

### Exemplary Embodiments

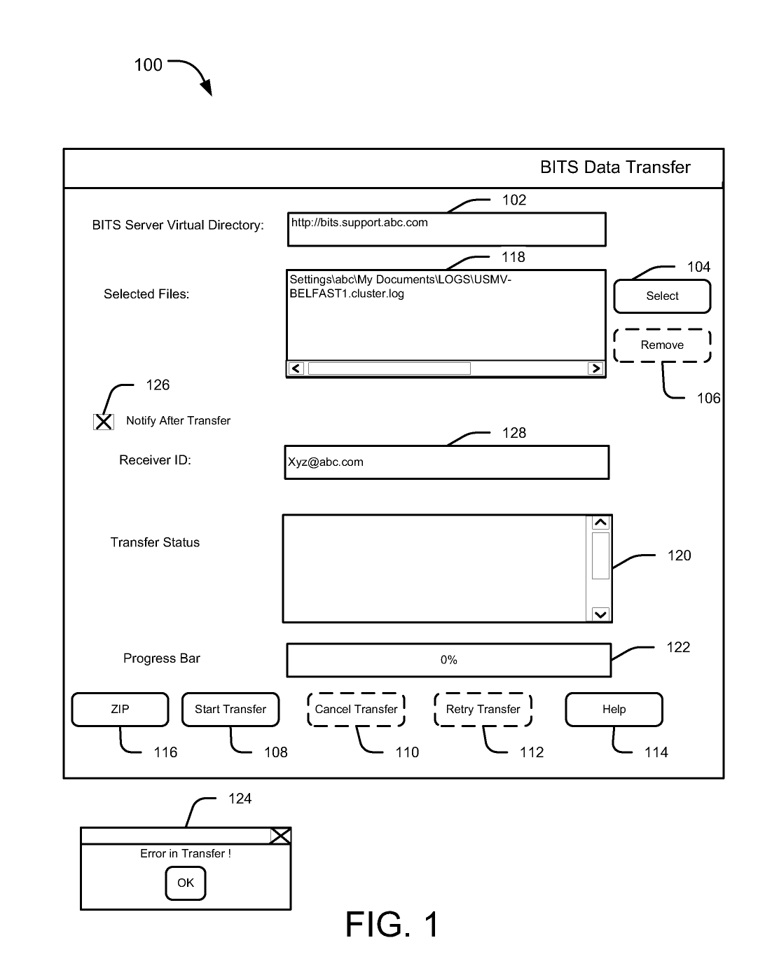

FIG. 1 illustrates a graphical user interface system 100 for BITS implemented in a conventional computer system having a processor, memory, and peripheral devices such as a display screen, a keyboard, and a pointing device. BITS includes a job having one or more files to transfer. The job possesses properties that specify how BITS transfers the files and interacts with an application. The files can be uploaded to a BITS Server Virtual Directory. BITS also includes BITS Administration Utility tool (“BITSAdmin tool”), a command-line tool used to create upload or upload-reply jobs and monitor their progress. The BITSAdmin tool utilizes switches to identify BITS functions to be performed.

The interface system 100 includes a set of input modules, such as directory module 102, a select module 104, a remove module 106, a start transfer module 108, a cancel transfer module 110, a retry transfer module 112, and a help module 114 displayed thereon. Each of the directory module 102 and the select module 104 selects one or more files for transfer to the BITS Server Virtual Directory. The directory module 102 receives a directory path for files to be transferred. The select module 104, when active, allows a user to click the select module 104 to initiate /Add file switch or /AddFileSet of the BITSAdmin tool. The /add file switch adds a single file for transfer by utilizing RemoteURL and LocalName as parameters. RemoteURL is the URL of the file on the server, and LocalName is the name of the file on a local computer. /AddFileSet adds one or more files for transfer and has TextFile parameter having a remote and local file name.

The remove module 106, the start transfer module 108, the cancel transfer module 110, the retry transfer module 112, and the help module 114 activate BITS functions for removing at least one of the selected files, starting file transfer, cancelling file transfer, retrying file transfer, and providing information about the interface system 100, respectively. As shown in FIG. 1, the remove module 106 is in default deactivated state and is activated only after at least one file is selected for transfer. The activated start transfer module 108, when clicked by the user, starts the file transfer function of BITS by initiating “/Create[/type]DisplayName” switch of the BITSAdmin tool. This switch creates a transfer job with the given “DisplayName”. “/Upload”, or “/Upload-Reply” can be used for the type parameter. The upload jobs transfer data from the local file to the server. The upload-reply jobs transfer data from a local file to the server and receive a reply file from the server. After the start transfer module 108 initiates the transfer, the cancel transfer module 110 switches from deactivate to active state. The activated cancel transfer module 110 can be clicked to initiate /CancelJob switch of BITSAdmin Tool to remove the job from the transfer queue and delete all temporary files associated with the job. The retry transfer module 112, corresponding to retrying the file transfer activates upon detection of an error in the transfer. When clicked, the retry transfer module 112 restarts the file transfer.

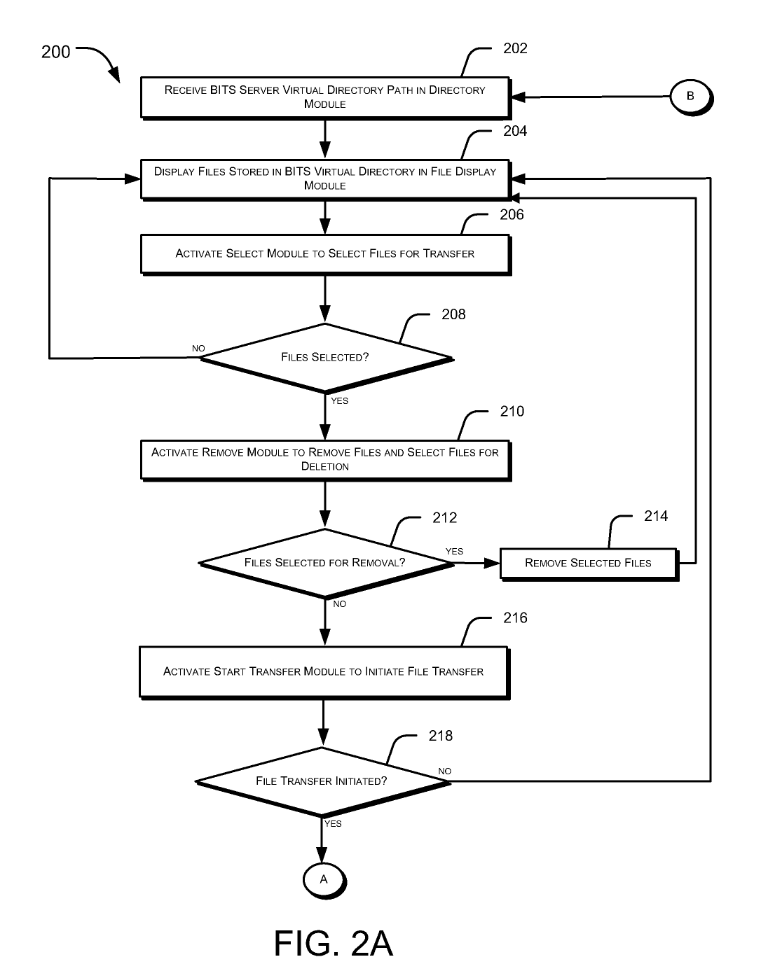

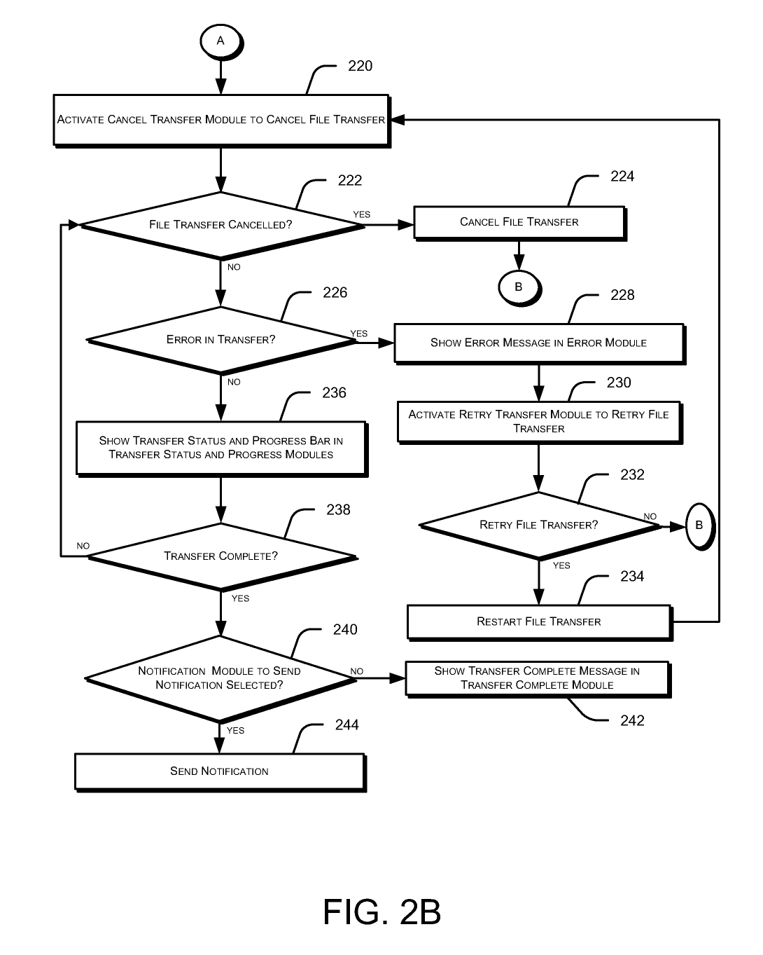

As shown in FIG. 1, the directory module 102 is a text box, while the remove module 106, as well as, the start transfer, cancel transfer, retry transfer, and help modules 108, 110, 112, and 114 are click-buttons. It will be evident to those skilled in the art that though FIG. 1 represents particular types of input modules, the interface system 100 may include different forms of input modules, such as radio buttons, and the like. The functionality of each of the set of input modules is explained in detail in conjunction with FIGS. 2A and 2B.

In some embodiments, the interface system 100 includes a zip module 116 to zip the selected files before transferring. Specifically, the zip module 116 compresses the files selected for transfer to reduce the file size.

The interface system 100 also includes a set of output modules such as a file display module 118, a transfer status module 120, a progress module 122, and an error module 124 displayed thereon. In the instant embodiment of the disclosure, the file display module 118 and the transfer status module 120 are scroll menus, the progress module 122 is a bar and the error module 124 is a pop-up box. Other types of output modules such as a moving-bar menu, a cascading menu, or the like may also be employed while developing the interface system 100.

The file display module 118 displays the files suitable for transfer, while the transfer status and the progress modules 120 and 122 automatically show dynamic status and real-time progress of the transfer, respectively, upon activation of the transfer of the selected files. Specifically, the transfer status module 120, when active, initiates “/GetBytesTransferred” switch to retrieve number of bytes transferred for the specified job, and the progress module 122, when active, initiates “/GetState” switch to retrieve the status of the specified job. The possible states include, without any limitation, “QUEUED”, “CONNECTING”, “TRANSFERRING”, “SUSPENDED”, “ERROR”, “TRANSIENT_ERROR”, “ACKNOWLEDGED”, AND “CANCELLED”. The state “QUEUED” specifies that the job is waiting to run, “CONNECTING” indicates BITS is contacting the server, “TRANSFERRING” specifies BITS is transferring data, and “SUSPENDED” indicates that the job is paused. The “ERROR” state specifies that a non-recoverable error has occurred, and the transfer will not be retried while the “TRANSIENT_ERROR” indicates that a recoverable error has occurred. The transfer is retried when the minimum retry delay expires. In addition, the “ACKNOWLEDGED” state indicates that the job has been completed while the cancelled job is represented by the “CANCELLED” state.

The error module 124 is displayed if an error is detected during the transfer of the selected files and shows an error message by initiating “/GetNotifyFlags” switch, which generates an event when the error occurs. In an embodiment of the instant disclosure, a transfer complete module (not shown) may be displayed in the interface system 100 indicating completion of the file transfer. The transfer complete module may be a pop-up box or any other type of interactive icon known in the art such as a tear-off menu, and the like. The functions enabled by the set of output modules are explained in detail in conjunction with FIGS. 2A and 2B.

The interface system 100 also includes a first notification module 126 and a second notification module 128 for providing a real-time notification on completion of the transfer of the selected files after initiating “/complete” switch of the BITSAdmin tool. In the instant embodiment of the disclosure, the second notification module 128 is a text box capable of receiving an e-mail address to which the notification of transfer completion is delivered. Using the first notification module 126, the decision of sending the notification is taken. The first notification module 126, when selected, initiates “/GetNotifyFlags” switch, which generates an event when all the selected files have been transferred. In the instant embodiment, the event is sending an e-mail on completion of the transfer to the e-mail address specified in the second notification module 128. Otherwise, the event may include sending a mobile alert indicating the completion of the transfer. As shown in FIG. 1, the first notification module 126 is a check box; however, it will be evident that any other type of input module such as radio button may be utilized.

In one implementation, the interface system 100 having the set of input modules, the set of output modules, and the notification modules are configured using JAVA programming. JAVA Swing provides interactive features that can be used to develop the interface system 100. It will be evident that any other high level programming language such as VB.Net may be used to develop the interface system 100.

FIG. 2A illustrates a flowchart of an exemplary embodiment of a method 200 for facilitating transfer of files in BITS using the interface system 100. The method 200 begins at block 202, where the directory module 102 receives BITS Server Virtual Directory Path. To enter the Directory Path in the directory module 102, the user positions the pointing device's cursor over the directory module 102, depresses the pointing device button to select it, and then types or copies the Directory Path into the field. The Directory Path specifies the location of the BITS Server Virtual Directory to which a file needs to be uploaded.

Once a connection to the specified BITS Virtual Directory is established, the file display module 118 displays a list of files available for transfer at block 204 in the file display module 118. In addition, at block 206 the select module 104 is activated and the user can select files for transfer. In the instant embodiment, the user selects one or more files from the list of files using the pointing device, thereby generating an event. When the event occurs in the directory module 102, the files are selected for transfer.

Before the file transfer begins, the method 200 checks whether at least one file is selected for the transfer at block 208. If no file is selected, the method 200 returns to the block 204, where the list of files suitable for transfer is displayed in the file display module 118; otherwise, the block 208 leads to block 210.

The block 210 activates the remove module 106 corresponding to removing files function, thereby enabling the user to delete one or more files from the selected files. Specifically, the user can select one or more files for removal using the pointing device. Block 212 checks whether one or more files are selected for removal from the selected files. If one or more files are selected for removal, the block 212 leads to block 214, where the user depresses the pointing device button on the remove module 106, thereby deleting the files specified at the block 210. After the files are deleted, the block 214 returns to the block 204, where the list of files is displayed in the file display module 118. If no files are selected for deletion, the block 212 leads to block 216.

At the block 216, the user depresses the pointing device button on the activated start transfer module 108 for initiating transfer of the selected files. Thereafter, block 218 confirms that the file transfer has been initiated. If it is determined that the file transfer is not initiated, the block 218 returns to the block 204, where the list of files for transfer are displayed in the file display module 118. Otherwise, the block 218 leads to a connector A.

FIG. 2B is a continuation of FIG. 2A, as depicted by the connector A. As shown in FIG. 2B, the block 218 leads to block 220, via the connector A, where the cancel transfer module 110 corresponding to the cancelling file transfer function is activated. The activation of the cancel transfer module 110 allows the user to select the cancel transfer module 110 to cancel the transfer. Specifically, the user selects the cancel transfer module 110 by depressing the pointing device button thereon. The block 220 leads to block 222, which determines whether the user cancels the file transfer. On determining that the user cancels the file transfer, the block 222 leads to block 224 where the BITSAdmin tool cancels the file transfer. The block 224 leads to a connector B, which returns to the block 202. In such a scenario, the user may enter the previous path to restart the previous file transfer, or a new path to start a new file transfer.

Otherwise, if it is determined at the block 222 that the cancel transfer module 110 for cancelling file transfer is not selected, the block 222 leads to block 226. The block 226 identifies an error in the transfer. The error can be either fatal or transient. For transient errors, BITS waits for a predetermined time and then retries the transfer. For fatal errors, BITS transfers control of the transfer to its creating application along with necessary information regarding the error.

If a fatal error is identified in the file transfer, the block 226 leads to block 228, where an error message is displayed in the error module 124. The error message may indicate to the user the reason for disruption in transfer. On identification of the error, the BITSAdmin tool activates the retry transfer module 112 corresponding to retrying file transfer, and the user can select the retry transfer module 112 by depressing the pointing device button, at block 230. If block 232 determines that the retry transfer module 112 is selected, the block 232 leads to block 234 where the BITSAdmin tool restarts the file transfer. Otherwise, the block 232 leads to the connector B to return the method 200 to the block 202, allowing the user to enter the Directory Path. Once the file transfer is re-started, the BITSAdmin tool activates the cancel transfer module 110 corresponding to the cancelling transfer function. Thereafter the user can select the cancel transfer module 110.

If there is no error in the file transfer, the block 226 leads to block 236, which automatically shows dynamic status and real-time progress of the transfer in the transfer status module 120 and the progress module 122, respectively. Specifically, once the file transfer begins successfully, the BITSAdmin tool automatically (without initiating any command prompt) displays the status of the transfer to the user in the transfer status module 120. In addition, the BITSAdmin tool automatically updates the progress bar displaying the percentage of file transfer completed in the progress module 122.

If block 238 determines that the file transfer is complete, the block 238 leads to block 240. Otherwise the method 200 returns to the block 222, where it is determined if the file transfer is cancelled. The block 240 determines whether the user selected the first notification module 126. The user can select the first notification module 126 by using the pointing device, thereby indicating that the BITSAdmin tool must send a notification to an e-mail address after completion of the file transfer. The user enters the e-mail address in the second notification module 128.

If the block 240 determines that the first notification module 126 is not selected, the block 240 leads to block 242, where the transfer complete module displays the transfer complete message; otherwise the block 240 leads to block 244. At the block 244, the BITSAdmin tool sends a notification to the e-mail address specified in the second notification module 128, notifying the user that the file transfer is complete.

It will be evident to a person skilled in the art that though the instant disclosure illustrates the functioning of the interface system 100 using the pointing device, other devices can be also be utilized to activate various modules of the interface system 100. The other devices may include a keyboard or a touch pad. Also, in an embodiment of the instant disclosure, the file transfer may include downloading files from the BITS Server Virtual Directory.

Those skilled in the art will understand that the system and methods set out in the discussion above may be combined or altered in specific adaptations of the disclosure. The illustrated system and methods are set out to explain the illustrated embodiments, and it should be anticipated that ongoing technological development will change the manner in which particular functions are performed. These depictions do not limit the scope of the disclosure, which is determined solely by reference to the appended claims.

### CONCLUSION

The instant disclosure provides the graphical user interface system 100 and the computer-implemented method 200 for facilitating transfer of files in BITS. The systems and methods disclosed herein provide a user-friendly manner of transferring files in BITS, without the need of remembering various commands related to the functions of BITS. In addition, the systems and methods integrate the benefits of the command-line interface and the graphical user interface.

The specification sets out a number of specific exemplary embodiments, but persons of skill in the art will understand that variations in these embodiments will naturally occur in the course of embodying the subject matter of the disclosure in specific implementations and environments. For example, any other interactive icons may be employed in the graphical user interface system, apart from those explained in the instant disclosure. It will further be understood that such variations, and others as well, fall within the scope of the disclosure. Neither those possible variations nor the specific examples set above are set out to limit the scope of the disclosure. Rather, the scope of claimed disclosure is defined solely by the claims set out below.

What is claimed is:

1. A graphical user interface system for Background Intelligent Transfer Service (BITS), the system comprising:
a set of input modules configured to:
select one or more files for transfer from BITS Server Virtual Directory; and
activate BITS functions including at least one of starting file transfer, cancelling file transfer, retrying file transfer, or removing at least one of the selected files;
a set of output modules configured to:
show automatically dynamic status and real-time progress of the transfer upon activation of the transfer of the selected files; and
display an error message upon detecting an error in the transfer; and
notification modules configured to provide a real-time notification on completion of the transfer.

2. The graphical user interface system of claim 1, wherein each input module from the set of input modules comprises at least one of a text box, a click-button, a scroll-down menu, or a check box.

3. The graphical user interface system of claim 1, wherein each output module from the set of output modules comprises at least one of a pop-up box, a bar, or a scroll-down menu.

4. The graphical user interface system of claim 1, wherein the notification module is configured to receive an e-mail address for sending the notification on completion of the transfer.

5. The graphical user interface system of claim 1, wherein an output module from the set of output modules is configured to automatically display a message on completion of the transfer.

6. The graphical user interface system of claim 1, wherein an input module from the set of input modules corresponding to retrying the file transfer is activated upon detection of the error in the transfer.

7. The graphical user interface system of claim 1 further comprises a zip module configured to zip the selected files before transferring.

8. A computer-implemented method for operating a graphical user interface system of Background Intelligent Transfer Service (BITS), the method comprising:
activating an input module from a set of input modules for selecting one or more files for transfer;
activating an input module from the set of input modules for initiating transfer of the selected files;
showing automatically dynamic status and real-time progress of the transfer upon activation of the transfer of the selected files in output modules from a set of output modules;
displaying automatically an error message upon detection of an error in the transfer, wherein the error message is displayed in an output module from the set of output modules; and
sending a real-time notification on completion of the transfer.

9. The computer-implemented method of claim 8 further comprising step of receiving BITS Server Directory path in an input module from the set of input modules for initiating display of the files stored in the BITS Server Virtual Directory in an output module from the set of output modules.

10. The computer-implemented method of claim 8 further comprising step of displaying files stored in the BITS Server Virtual Directory in an output module from the set of output modules, wherein one or more files are selected from the displayed files for transfer.

11. The computer-implemented method of claim 8 further comprising steps of:
receiving an e-mail address in a notification module;
sending a real-time notification to the received e-mail address upon completion of the transfer.

12. The computer-implemented method of claim 8 further comprising step of activating an input module from the set of input modules for removing at least one file from the selected files.

13. The computer-implemented method of claim 8 further comprising step of activating an input module from the set of input modules for cancelling the transfer of the selected files.

14. The computer-implemented method of claim 8, wherein the displaying step further comprises activating an input module from the set of input modules corresponding to retrying the file transfer.

15. The computer-implemented method of claim 8, wherein the step of activating the input module for selecting one or more files for transfer comprises activating at least one of a click-button, a scroll-down menu, or a check box.

16. The computer-implemented method of claim 8, wherein the step of activating the input module for initiating transfer of the selected files comprises activating at least one a click-button, or a check box.

17. The computer-implemented method of claim 8, wherein the step of showing automatically dynamic status and real-time progress of the transfer comprises displaying the dynamic status and the real-time progress in at least one of a pop-up box, a bar, or a scroll-down menu.

18. A graphical user interface system for Background Intelligent Transfer Service (BITS), the system comprising:
a set of input modules configured to:
select one or more files for transfer from BITS Server Virtual Directory by activating at least one input module from the set of input modules including a click-button, a scroll-down menu, or a check box; and
initiate BITS functions including at least one of starting file transfer, cancelling file transfer, retrying file transfer, or removing at least one of the selected files by activating at least one input module from the set of input modules including a click-button, or a check box;
a set of output modules configured to:
show automatically dynamic status and real-time progress of the transfer upon activation of the transfer of the selected files in at least one output module from the set of output modules including a pop-up box, a bar, or a scroll-down menu; and
display an error message upon detecting an error in the transfer, wherein the error message is displayed in at least one output module from the set of output modules including a pop-up box, or a scroll-down menu; and
a notification module configured to provide a real-time notification on completion of the transfer.

19. A graphical user interface system for Background Intelligent Transfer Service (BITS), including BITSAdmin tool, the system comprising:
a set of input modules configured to:
select one or more files for transfer to BITS Server Virtual Directory by initiating /Addfile switch or /AddFileSet of the BITSAdmin tool; and
activate BITS functions including at least one of starting file transfer, cancelling file transfer, retrying file transfer, or removing at least one of the selected files;
a set of output modules configured to:
show automatically dynamic status and real-time progress of the transfer by initiating /GetBytesTransferred switch and /GetState switch of the BITSAdmin tool upon activation of the transfer of the selected files; and
display an error message upon detecting an error in the transfer by initiating /GetNotifyFlags switch of the BITSAdmin tool; and
a notification module configured to provide a real-time notification on completion of the transfer after initiating /complete switch of the BITSAdmin tool.
